(19) United States
(12) Patent Application Publication
(10) Pub. No.: US 2016/0225559 A1
(43) Pub. Date: Aug. 4, 2016

(54) POWER SUPPLY SYSTEM

(71) Applicant: Renesas Electronics Corporation, Tokyo (JP)

(72) Inventor: Takanori UEKI, Tokyo (JP)

(21) Appl. No.: 14/946,628

(22) Filed: Nov. 19, 2015

(30) Foreign Application Priority Data
Jan. 29, 2015 (JP) 2015-015152

(51) Int. Cl. H01H 47/00

(52) U.S. Cl. CPC H01H 47/00

(57) ABSTRACT

A power supply system according to an embodiment includes a USB connector and performs a power supply operation from a power supply circuit via the USB connector. A power supply apparatus includes a first power supply line of the power supply circuit that outputs a plurality of power supply voltages, a plurality of constant voltage diodes that each have breakdown voltages corresponding to the plurality of power supply voltages, and a control circuit that selects one of the plurality of power supply voltages as a power supply voltage which will be output from the power supply circuit and selects the constant voltage diode which will be connected to the first power supply line from among the plurality of constant voltage diodes.

### CROSS-REFERENCE TO RELATED APPLICATIONS

This application is based upon and claims the benefit of priority from Japanese patent application No. 2015-015152, filed on Jan. 29, 2015, the disclosure of which is incorporated herein in its entirety by reference.

### BACKGROUND

The present invention relates to a power supply system and to, for example, a power supply system which can select a charging voltage.

In related art, a technique for attenuating a surge voltage that is generated in a power supply line using a constant voltage diode has been known. In Japanese Patent No. 4635535, a constant voltage diode having a predetermined breakdown voltage value is disposed between a power supply line and a GND line. When a pulsed surge voltage exceeding a breakdown voltage is applied to the cathode of the constant voltage diode, the constant voltage diode becomes conductive and an impedance is reduced, thereby reducing a maximum value of the surge voltage to less than or equal to the breakdown voltage value.

In recent years, many electronic devices such as a personal computer include a USB (Universal Serial Bus) interface. USB devices including a smart phone and a tablet terminal are connected to the electronic devices via the USB interfaces to enable data communication.

Moreover, the USB devices can be supplied with power from the electronic devices via the USB interfaces. Therefore, the battery of the USB device can be charged with the power supplied via the USB interface. An electronic device that is compliant with the USB power delivery standard can select the power supply voltage from among 5 V, 12 V, and 20 V according to the USB device which will be connected thereto.

### SUMMARY

In the USB power delivery standard, a plurality of power supply voltages are selectively supplied to the same power supply line. Along with the introduction of the USB power delivery standard, the power supply voltage which will be output to the USB interface can be made variable, thereby requiring that there be an effective measure for reducing a surge voltage according to a supported range of the power supply voltage.

In the technique disclosed in Japanese Patent No. 4635535, a single constant voltage diode is disposed. A breakdown voltage of the constant voltage diode is uniquely determined. Accordingly, the constant voltage diode having a breakdown voltage corresponding to a power supply voltage and an allowable surge voltage is used.

As disclosed in Japanese Patent No. 4635535, when a single constant voltage diode is used as a measure to reduce the surge voltage in electronic devices that are compliant with the USB power delivery standard, it is necessary to use the constant voltage diode having the breakdown voltage that covers a maximum power supply voltage which is supported and the allowable surge voltage. However, the present inventor has found out a problem that when a minimum power supply voltage which is supported is selected, a value of the surge voltage that has been reduced by the constant voltage diode will become large.

Other issues and new feature will become apparent from the following description of the specification and attached drawings.

An aspect of the present invention is a power supply system including a USB interface for performing a power supply operation from a power supply circuit via the USB interface. The power supply system includes a first power supply line of the power supply circuit that outputs a plurality of power supply voltages, a plurality of constant voltage diodes that each have breakdown voltages corresponding to the plurality of power supply voltages, and a control circuit that selects one of the plurality of power supply voltages as a power supply voltage which will be output from the power supply circuit and selects one of the plurality of constant voltage diodes which will be connected to the first power supply line according to the selected power supply voltage.

According to the above aspect, it is possible to effectively reduce the surge voltage in the power supply system that supplies different power supply voltages to the power supply line.

### BRIEF DESCRIPTION OF THE DRAWINGS

The above and other aspects, advantages and features will be more apparent from the following description of certain embodiments taken in conjunction with the accompanying drawings, in which:

FIG. 1 is a drawing showing a schematic configuration of a power supply system according to an embodiment;

FIG. 2 is a drawing showing a configuration of the power supply system according to a first embodiment;

FIG. 3A is a graph showing a waveform of a surge voltage in the power supply system according to the first embodiment;

FIG. 3B is a graph showing a waveform of a surge voltage in the power supply system according to the first embodiment;

FIG. 3C is a graph showing a waveform of a surge voltage in the power supply system according to the first embodiment;

FIG. 4 is a drawing showing the rest of the configuration of the power supply system according to the first embodiment;

FIG. 5 is a drawing showing a configuration of a power supply system according to a second embodiment;

FIG. 6A is a graph showing a waveform of a surge voltage in the power supply system according to the second embodiment;

FIG. 6B is a graph showing a waveform of the surge voltage in the power supply system according to the second embodiment;

FIG. 6C is a graph showing a waveform of the surge voltage in the power supply system according to the second embodiment;

FIG. 7 is a drawing showing a configuration of a power supply system according to a third embodiment;

FIG. 8A is a drawing showing a configuration of a surge absorber circuit that is used in the power supply system according to the embodiment;

FIG. 8B is a drawing showing the rest of the configuration of the surge absorber circuit that is used in the power supply system according to the embodiment;

FIG. 9 is a drawing showing a comparative example of a power supply system;

FIG. 10A is a drawing showing a waveform of a surge voltage in the comparative example of the power supply system; and

FIG. 10B is a drawing showing a waveform of the surge voltage in the comparative example of the power supply system.

### DETAILED DESCRIPTION

Hereinafter, preferred embodiments shall be explained with reference to the drawings. Specific numerical values mentioned in the following embodiments are merely illustrative for easier understanding of the invention, and unless otherwise specified in particular, these embodiments are not limited by these numerical values. Further, to clarify the explanation, matters that are obvious to those skilled in the art in the following descriptions and drawings have been omitted or simplified as appropriate.

An embodiment relates to a power supply system that is compliant with the USB power delivery standard and can select a plurality of power supply voltages. The power supply system according to the embodiment includes a surge absorber circuit for attenuating a surge voltage that is generated at the time of hot swapping.

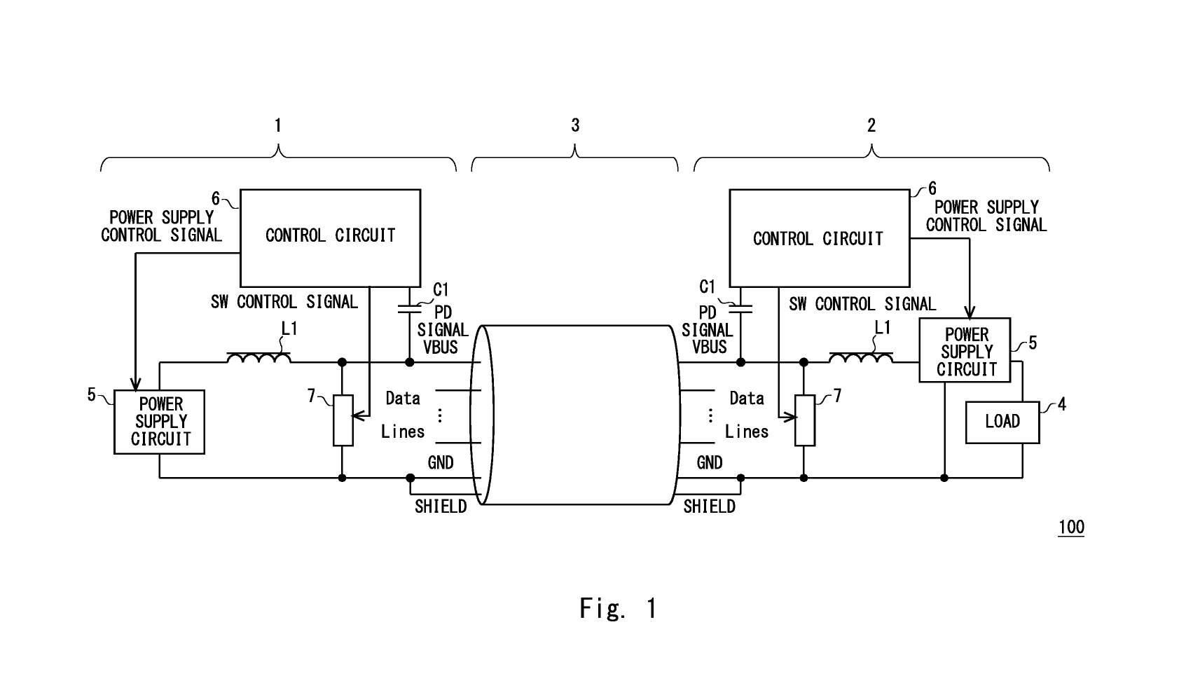

A schematic configuration of a power supply system 100 according to the embodiment shall be explained with reference to FIG. 1. As shown in FIG. 1, the power supply system 100 according to the embodiment includes a power supply apparatus 1, a power receiving apparatus 2, and a connection cable 3. The power supply apparatus 1 is connected to the power receiving apparatus 2 using the connection cable 3. The power supply apparatus 1 supplies power to the power receiving apparatus 2 which is a USB device.

Note that in the embodiment, although an example in which the power supply apparatus 1 and the power receiving apparatus 2 are connected using the connection cable 3 is described, a USB terminal of the power supply apparatus 1 and a USB terminal of the power receiving apparatus 2 may be directly connected. The power supply apparatus 1 and the power receiving apparatus 2 are connected via first power supply lines VBUS, second power supply lines GND, and data lines of the connection cable 3.

The power supply apparatus 1 and the power receiving apparatus 2 have the same configuration except that the latter includes a load 4, and thus repeated descriptions shall be omitted as appropriate. The power supply apparatus 1 includes a power supply circuit 5, a control circuit 6, and a surge absorber circuit 7. The power receiving apparatus 2 has the same configuration as that of the power supply apparatus 1 and further includes the load 4 which is supplied with power.

The power supply circuit 5 outputs a plurality of different power supply voltages using the first power supply line VBUS. In this example, the power supply circuit 5 can select a power supply voltage from among 5 V, 12 V, and 20 V according to the power receiving apparatus 2 which will be connected thereto. The power supply circuit 5 is connected to the first power supply line VBUS and the second power supply line GND. A DC coupling inductor L1 is disposed on the first power supply line VBUS that is between the power supply circuit 5 and the connection cable 3. The DC coupling inductor L1 is disposed to propagate only a DC component of a signal propagating through the first power supply line VBUS to the power supply circuit 5.

The control circuit 6 sets the power supply voltage of the power supply circuit 5 and controls the surge absorber circuit 7, which will be explained later. The control circuit 6 is connected to the first power supply line VBUS via an AC coupling capacitor C1. The AC coupling capacitor C1 is disposed to propagate only an AC component of a signal propagating through the first power supply line VBUS to the control circuit 6.

The control circuit 6 generates a power supply control signal for selecting one of the plurality of power supply voltages based on the AC component (a power delivery signal (hereinafter referred to as a PD signal)) of the signal that is supplied using the first power supply line VBUS. The power supply control signal is supplied to the power supply circuit 5. Further, the control circuit 6 generates an SW control signal for controlling the surge absorber circuit 7 based on the power supply control signal. The SW control signal is supplied to the surge absorber circuit 7.

The surge absorber circuit 7 absorbs the surge voltage at the time of an insertion and removal of the connection cable 3. The surge absorber circuit 7 is disposed between the first power supply line VBUS and the second power supply line GND. In the embodiment, the surge absorber circuit 7 is disposed to cover the different power supply voltages which are selected by the power supply circuit 5 so as to effectively reduce the surge voltage. Hereinafter, a specific configuration example of the power supply system 100 including the surge absorber circuit 7 shall be explained. In the following drawings, the same elements as those in FIG. 1 are denoted by the same reference numerals as those in FIG. 1.

### First Embodiment

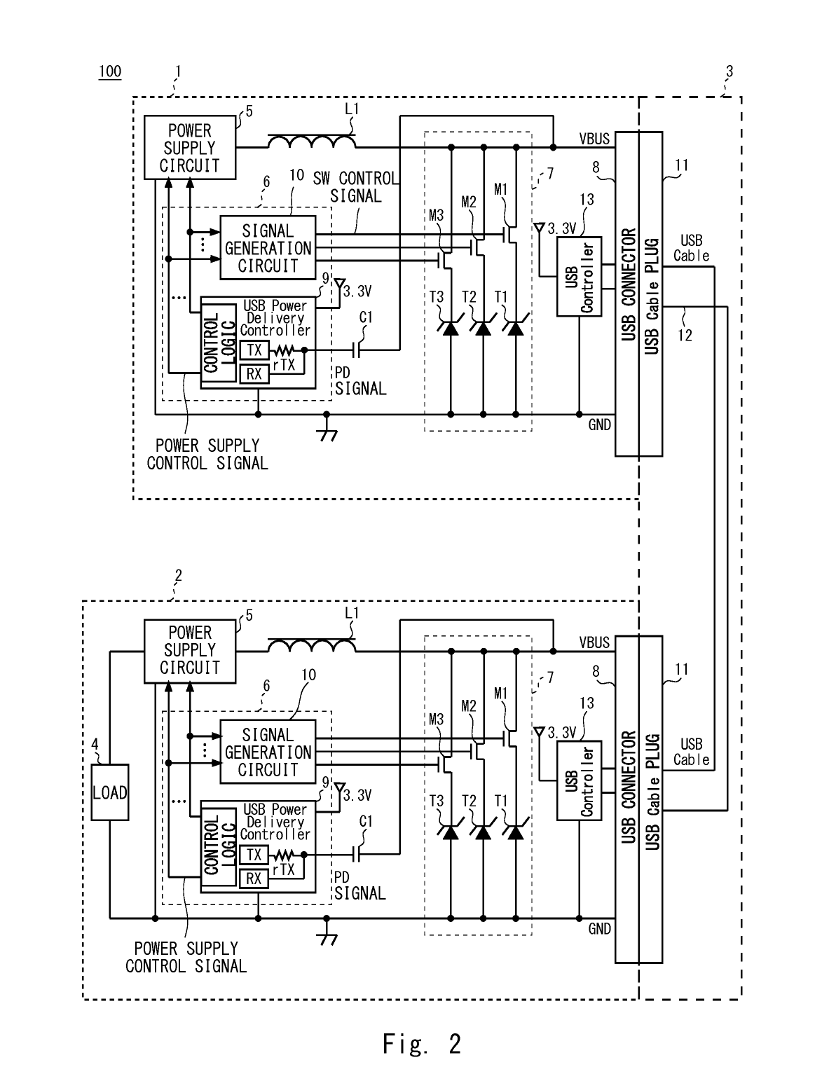

FIG. 2 is a drawing showing a configuration of a power supply system according to a first embodiment. As shown in FIG. 2, the power supply system 100 includes the power supply apparatus 1, the power receiving apparatus 2, and the connection cable 3. As described above, the power supply apparatus 1 and the power receiving apparatus 2 have the same configuration except for the load 4. Firstly, the power supply apparatus 1 shall be explained below.

The power supply apparatus 1 includes the power supply circuit 5, the control circuit 6, the surge absorber circuit 7, a USB connector 8, and a USB controller 13. The USB connector 8 is a USB interface. The connection cable 3 is connected to the USB connector 8.

The connection cable 3 includes USB cable plugs 11 and a USB cable 12. The USB cable plugs 11 of the connection cable 3 are inserted into the respective USB connectors 8 of the power supply apparatus 1 and the power receiving apparatus 2. The USB cable plugs 11 of the connection cable 3 are connected using the USB cable 12. The USB cable 12 includes first power supply lines VBUS, second power supply lines GND, and signal lines which have been explained by referring to FIG. 1. The connection cable 3 performs a USB power delivery signal communication (PD signal communication), a power supply, and a USB data communication between the power supply apparatus 1 and the power receiving apparatus 2.

The control circuit 6 includes a USB power delivery controller 9 and a signal generation circuit 10. The control circuit 6 can be configured in one chip. The USB power delivery controller 9 performs communications using the PD signal between the power supply apparatus 1 and the power receiving apparatus 2 and generates a power supply control signal for selecting one of a plurality of power supply voltages as a power supply voltage which will be output from the power supply circuit 5 to the first power supply line VBUS. The power supply control signal is supplied to the power supply circuit 5 and the signal generation circuit 10. The signal generation circuit 10 generates the SW control signal for controlling the surge absorber circuit 7 based on the power supply control signal.

The surge absorber circuit 7 includes a first constant voltage diode T1, a second constant voltage diode T2, a third constant voltage diode T3, a first switch Ml, a second switch M2, and a third switch M3. The first to third switches M1 to M3 are comprised of, for example, an FET (Field Effect Transistor). The cathode of the first constant voltage diode T1 is connected to the first power supply line VBUS via the first switch M1. The anode of the first constant voltage diode T1 is connected to the second power supply line GND.

The cathode of the second constant voltage diode T2 is connected to the first power supply line VBUS via the second switch M2. The anode of the second constant voltage diode T2 is connected to the second power supply line GND. Further, the cathode of the third constant voltage diode T3 is connected to the first power supply line VBUS via the third switch M3. The anode of the third constant voltage diode T3 is connected to the second power supply line GND. That is, the first to third constant voltage diodes T1 to T3 are connected in parallel between the first power supply line VBUS and the second power supply line GND.

The first constant voltage diode T1 has breakdown voltage characteristics that are suitable for the power supply voltage of 20 V. To be specific, the first constant voltage diode T1 has a breakdown voltage corresponding to the sum of the power supply voltage 20 V and the allowable surge voltage. The second constant voltage diode T2 has breakdown voltage characteristics that are suitable for the power supply voltage of 12 V. To be specific, the second constant voltage diode T2 has a breakdown voltage corresponding to the sum of the power supply voltage of 12 V and the allowable surge voltage. The third constant voltage diode T3 has breakdown voltage characteristics that are suitable for the power supply voltage of 5 V. To be specific, the third constant voltage diode T3 has a breakdown voltage corresponding to the sum of the power supply voltage 5 V and the allowable surge voltage.

The first to third switches M1 to M3 are controlled by the SW control signal that is supplied by the signal generation circuit 10. One of the first to third switches M1 to M3 is switched on according to the SW control signal. Specifically, the signal generation circuit 10 selects one of the first to third constant voltage diodes T1 to T3 as a constant voltage diode which will be connected to the first power supply line VBUS according to the power supply voltage selected by the power supply control signal.

When one of the power supply voltages is selected, which power supply voltages correspond to the respective first to third constant voltage diodes T1 to T3, and a surge voltage exceeding the breakdown voltage of the corresponding one of first to third constant voltage diodes T1 to T3 is applied, the corresponding one of first to third constant voltage diodes T1 to T3 function to reduce a maximum value of the surge voltage to the breakdown voltage value thereof.

The USB controller 13 controls the USB data communications between the power supply apparatus 1 and the power receiving apparatus 2. A downstream side of the USB controller 13 is connected to the connection cable 3. Note that an upstream side of the USB controller 13 is connected to a higher-order apparatus, a bus or the like which is not shown.

Next, the power receiving apparatus 2 shall be explained below. The power receiving apparatus 2 has the same configuration as that of the power supply apparatus 1 except that it further includes the load 4. The load 4 is connected to the power supply circuit 5 and the second power supply line GND.

An operation of the power supply system 100 shown in FIG. 2 shall be explained as follows. When the power supply apparatus 1 and the power receiving apparatus 2 are connected by the connection cable 3, in the power supply apparatus 1, firstly the power supply circuit 5 selects the specified power supply voltage of 5 V. In the power supply apparatus 1, the power supply voltage of 5 V is stepped down to 3.3 V, and the power supply voltage of 3.3 V is supplied to the USB power delivery controller 9.

On the other hand, in the power receiving apparatus 2, the power supply voltage of 5 V is supplied to the power supply circuit 5, the power supply voltage of 5 V is stepped down to 3.3 V, and the power supply voltage of 3.3 V is supplied to the USB power delivery controller 9. At this time, the power supply voltage for driving the load 4 is not generated, and the power supply voltage is not supplied to the load 4.

Each of the signal generation circuits 10 in the power supply apparatus 1 and the power receiving apparatus 2 firstly generates the SW control signal that turns on the third constant voltage diode T3 having breakdown voltage characteristics that correspond to the power supply voltage of 5 V. It is thus possible to reduce the surge voltage that is generated at the time of the insertion of the connection cable 3.

When the USB power delivery controllers 9 start up, the power delivery controllers 9 in the power supply apparatus 1 and the power receiving apparatus 2 perform the PD signal communication (FSK (Frequency Shift Keying) communication) using the first power supply line VBUS. The USB power delivery controller 9 in the power supply apparatus 1 generates the power supply control signal for selecting the power supply voltage based on the PD signal. In this manner, the power supply voltage supplied from the power supply apparatus 1 to the power receiving apparatus 2 is determined.

The power supply circuit 5 in the power supply apparatus 1 changes the power supply voltage according to the power supply control signal that is output from the USB power delivery controller 9, and outputs the changed power supply voltage to the power receiving apparatus 2. At the same time, the power supply control signal is supplied to the signal generation circuit 10. The signal generation circuit 10 generates the SW control signal for controlling the surge absorber circuit 7 according to the power supply control signal. The SW control signal for selecting one of the first to third constant voltage diodes T1 to T3 can be easily generated by the signal generation circuit 10 as a logical signal that is substantially equivalent to the power supply control signal.

On the other hand, in the power receiving apparatus 2, the power is supplied to the load 4 via the first power supply line VBUS using the power supply voltage input from the power supply apparatus 1. At this time, the power supply circuit 5 in the power receiving apparatus 2 will not generate the power supply voltage for driving the load 4. However, the power supply circuit 5 in the power receiving apparatus 2 continues to generate the power supply voltage of 3.3 V in order to supply it to the USB power delivery controller 9 in the power receiving apparatus 2.

Further, the USB power deliver controller 9 in the power receiving apparatus 2 also generates the power supply control signal based on the PD signal. In response to the power supply control signal, the signal generation circuit 10 generates the SW control signal for controlling the surge absorber circuit 7 in the power receiving apparatus 2.

The first to third switches M1 to M3 of the surge absorber circuits 7 in the power supply apparatus 1 and the power receiving apparatus 2 are controlled to be on/off by the SW control signals that are input from the respective signal generation circuits 10. In this manner, one of the first to third constant voltage diodes T1 to T3 that is suitable for the selected power supply voltage is selected.

When the power supply voltage of, for example, 20 V is selected, the first switch M1 is switched on, the second switch M2 is switched off, and the third switch M3 is switched off. This activates the first constant voltage diode T1 having the breakdown voltage characteristics that are suitable for the power supply voltage of 20 V.

Likewise, when the power supply voltage of 12 V is selected, the first switch M1 is switched off, the second switch M2 is switched on, and the third switch M3 is switched off. This activates the second constant voltage diode T2 having the breakdown voltage characteristics that are suitable for the power supply voltage 12 V.

Further, when the power supply voltage of 5 V is selected, the first switch M1 is switched off, the second switch M2 is switched off, and the third switch M3 is switched on. This activates the third constant voltage diode T3 having the breakdown voltage characteristics that are suitable for the power supply voltage of 5 V. As described above, in the power supply system according to the first embodiment, it is possible to select the constant voltage diode having the breakdown voltage characteristics that are suitable for the power supply voltage setting using the power supply control signal for controlling the power supply voltages (20 V, 12 V, and 5V) of the power supply circuit 5, in which the power supply control signal is generated by the USB power delivery controller 9.

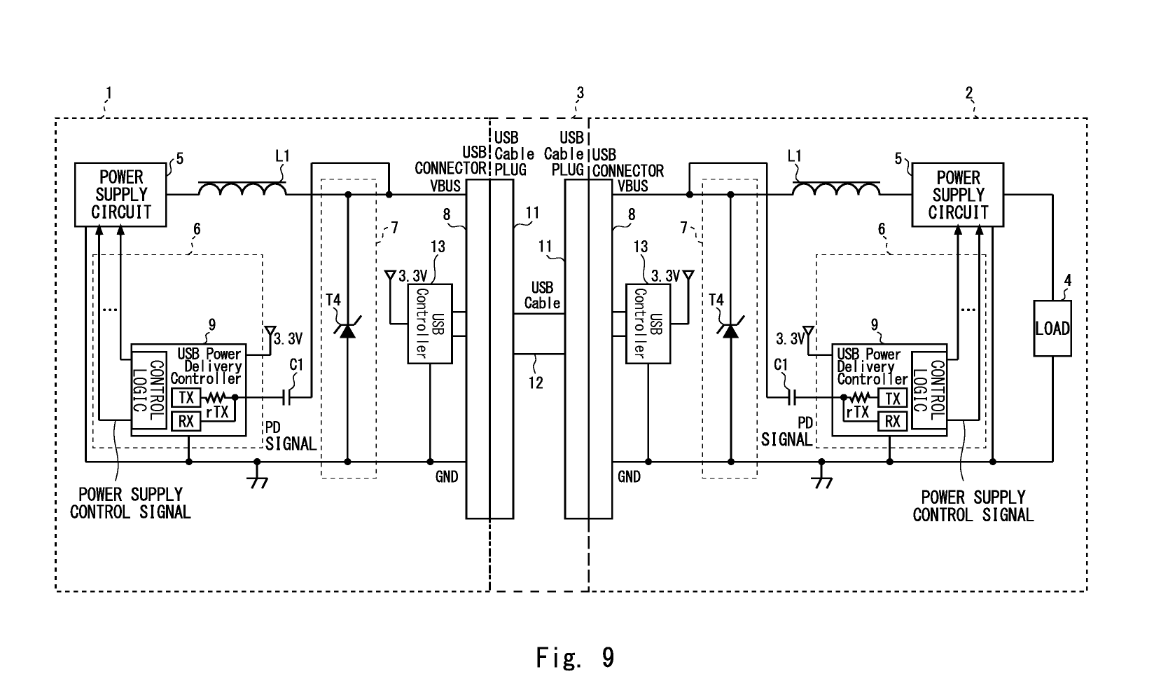

Next, a comparative example in which only one constant voltage diode is disposed as a surge absorber circuit in a power supply system that is compliant with the above-mentioned USB power delivery standard shall be explained with reference to FIG. 9. The power supply circuit 5 can select one of the power supply voltages of 5 V, 12 V, and 20 V. As shown in FIG. 9, a fourth constant voltage diode T4 is disposed between the first power supply line VBUS and the second power supply line GND.

As described above, when a single constant voltage diode is used as a measure to reduce the surge voltage in the electronic devices that are compliant with the USB power delivery standard, it is necessary to use the constant voltage diode having a breakdown voltage corresponding to a maximum power supply voltage which is supported and the allowable surge voltage.

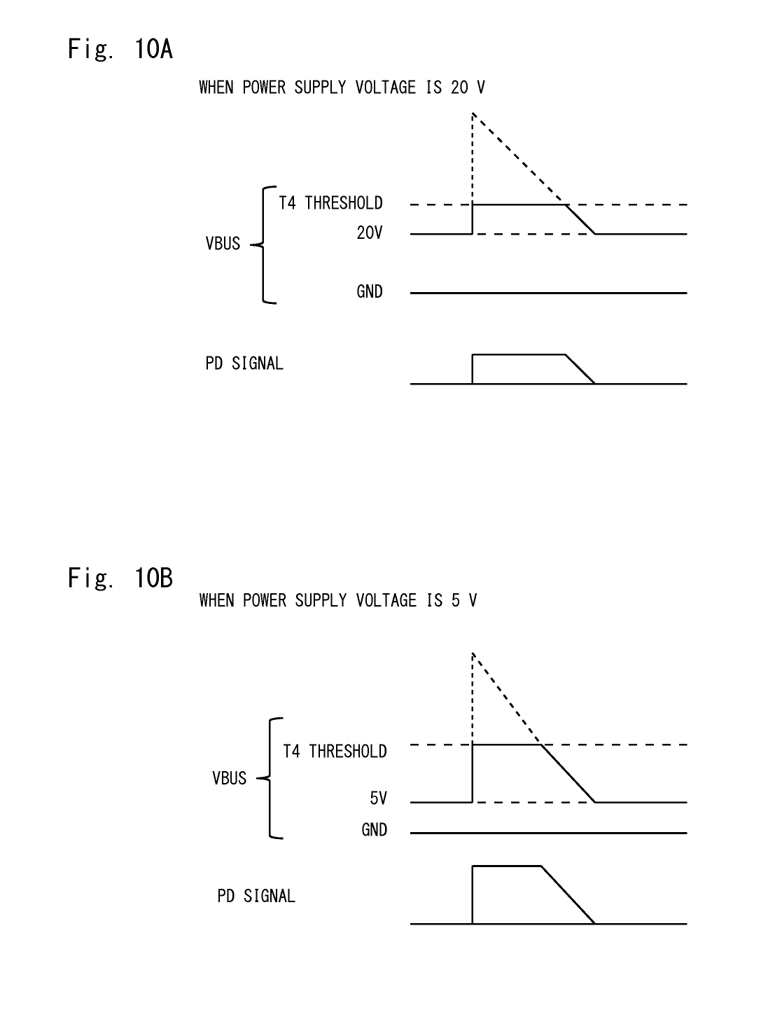

In the comparative example shown in FIG. 9, the fourth constant voltage diode T4 has breakdown voltage characteristics corresponding to the sum of the power supply voltage 20 V and the allowable surge voltage. FIGS. 10A and 10B show waveforms of the surge voltage in the comparative example shown in FIG. 9. A breakdown voltage of the fourth constant voltage diode T4 shall be referred to as a T4 threshold. FIG. 10A shows the case when 20 V is selected as the power supply voltage, and FIG. 10B shows the case when 5 V is selected as the power supply voltage.

As shown in FIG. 10A, when the power supply voltage is 20 V, a potential is clamped to the T4 threshold, and the surge voltage is reduced. On the other hand, as shown in FIG. 10B, when the power supply voltage is 5 V, in a manner similar to that in the above case, a potential is clamped to the T4 threshold. However, as the T4 threshold has been set for handling the power supply voltage of 20 V, an effect of reducing the surge voltage is low, thereby increasing the value of the surge voltage. The surge voltage propagates, by AC coupling, through a terminal of the USB power delivery controller 9 shown in FIG. 9, to which the PD signal is input. This may cause a circuit connected to the input terminal of the USB power delivery controller 9 for the PD signal to be broken.

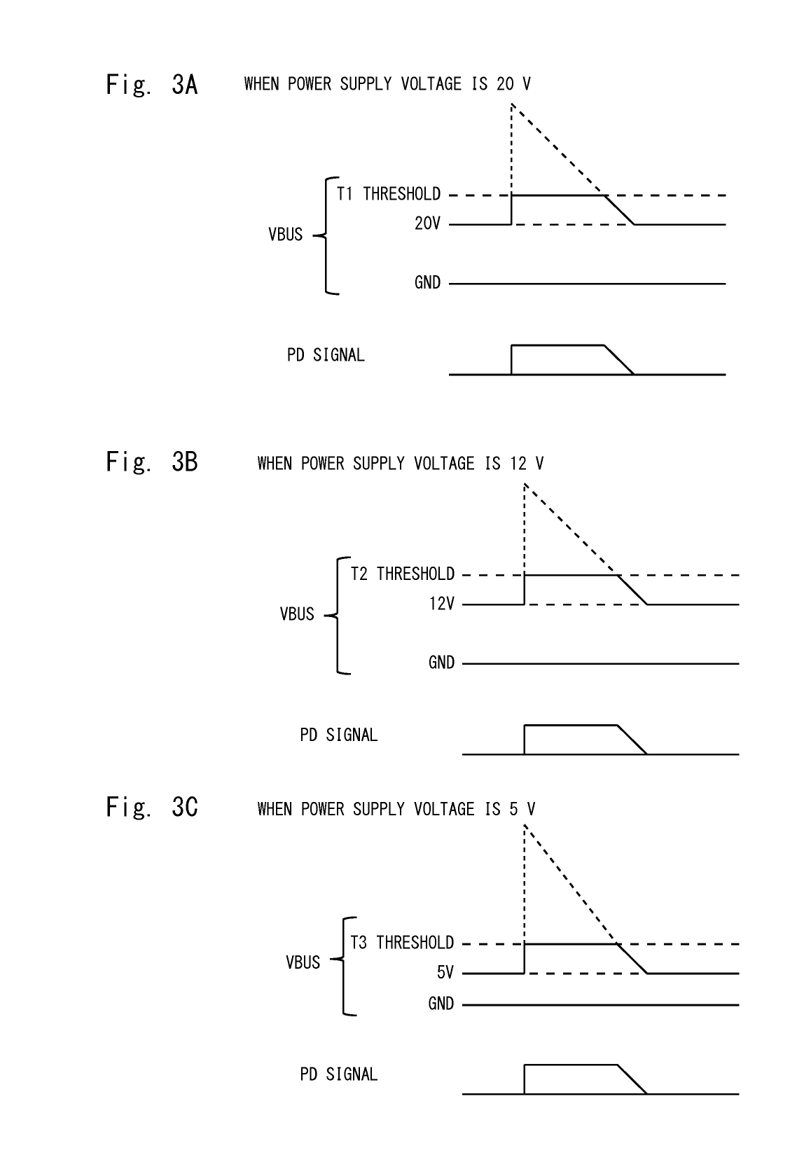

In comparison, FIGS. 3A to 3C show waveforms of the surge voltage in the power supply system 100 according to the first embodiment. FIG. 3A shows the case when 20 V is selected as the power supply voltage, FIG. 3B shows the case when 12 V is selected as the power supply voltage, and FIG. 3C shows the case when 5 V is selected as the power supply voltage. A breakdown voltage of the first constant voltage diode T1 shall be referred to as a T1 threshold, a breakdown voltage of the second constant voltage diode T2 shall be referred to as a T2 threshold, and a breakdown voltage of the third constant voltage diode T3 shall be referred to as a T3 threshold.

In the embodiment, the constant voltage diode having the breakdown voltage characteristics that are appropriate for the selected one of the power supply voltages 20 V, 12 V, and 5 V is selected. Accordingly, when any one of the power supply voltages of 20 V, 12 V, and 5 V is selected, an operation of unnecessarily drawing a current from the first power supply line VBUS will not be caused to occur during a normal operation.

Moreover, each of the constant voltage diodes which will be selected has the breakdown voltage characteristics that are suitable for each of the power supply voltages. It is thus possible to effectively reduce the surge voltage at the time of hot-swapping when any one of the power supply voltages is selected as shown in FIGS. 3A to 3C. Therefore, unlike the comparative example shown in FIG. 9, it is possible to avoid a problem that the value of the surge voltage becomes large when a low power supply voltage is selected. In this manner, even when the surge voltage that is reduced by the surge absorber circuit 7 propagates through the input terminal of the USB power delivery controller 9 for the PD signal, it is possible to avoid breaking of a circuit which is connected to the input terminal.

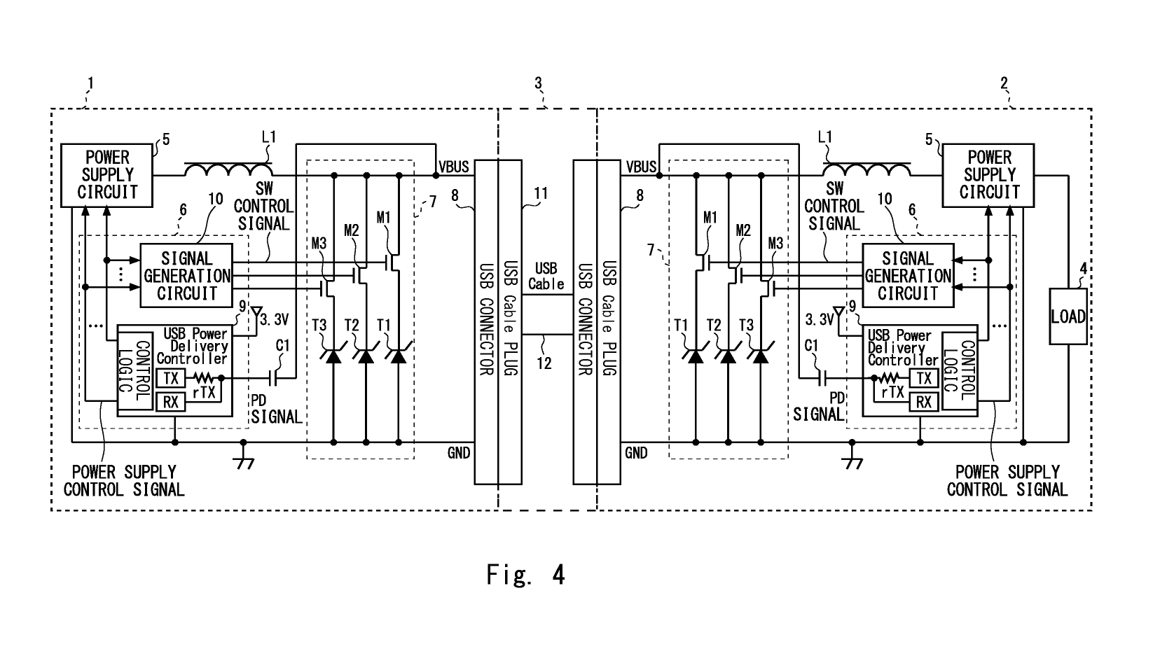

Note that although the USB data communications are performed between the USB controllers 13 in the power supply apparatus 1 and the power receiving apparatus 2, the USB data communications are performed independently from the PD signal communications by the USB power delivery controller 9. For this reason, the invention according to the embodiment can be applied to a power supply system that does not perform the USB data communications and only supplies power. FIG. 4 shows the rest of the configuration of the power supply system according to the first embodiment. As shown in FIG. 4, the power supply system may be configured such that the power supply apparatus 1 and the power receiving apparatus 2 do not include the USB controller 13 and do not perform data communications.

The power supply system according to the embodiment may be applied to, for example, a USB charger that is supplied with power from an outlet. The power supply apparatus 1 including the control circuit 6 that can select the power supply voltage, the surge absorber circuit 7 and the like is disposed on an adaptor which will be inserted into the outlet, and when connecting the power receiving apparatus 2 to the power supply apparatus 1, it is possible to realize a USB charger to which the power supply system according to this embodiment.

### Second Embodiment

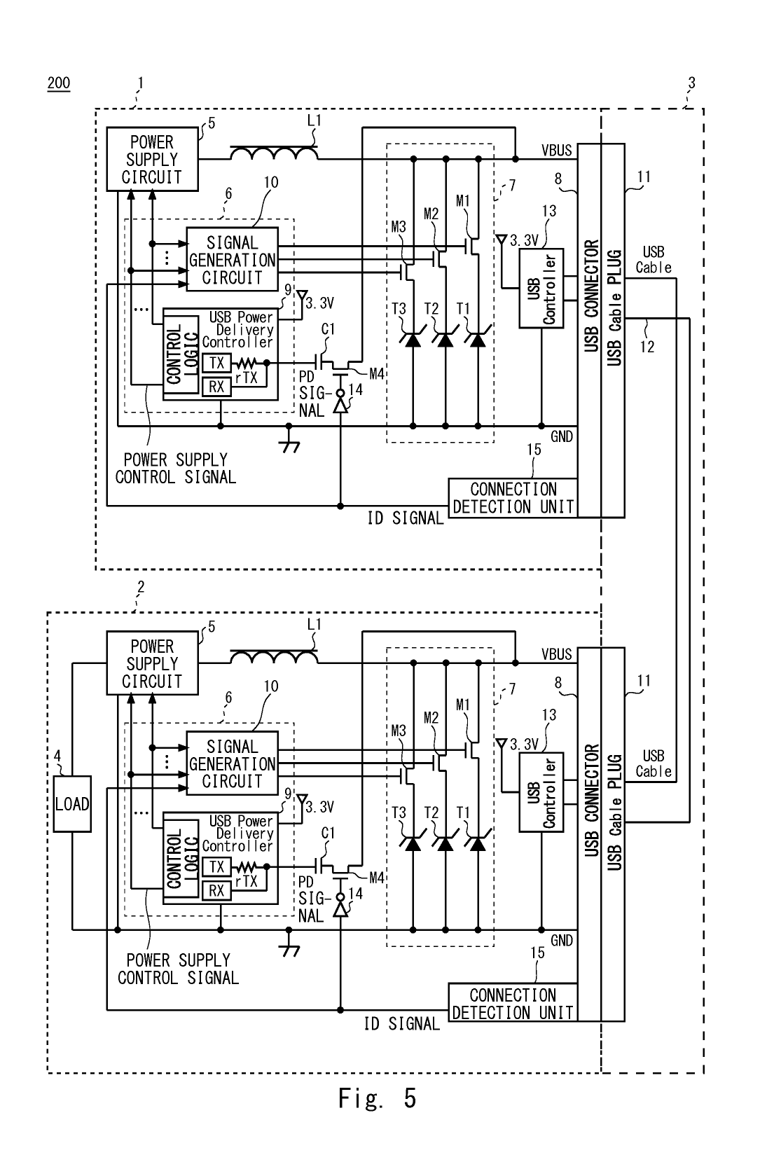

A configuration of a power supply system 200 according to a second embodiment shall be explained with reference to FIG. 5. Hereinafter, descriptions of the configuration that is the same as that of the first embodiment shall be omitted, and only contents different from those of the first embodiment shall be described. In the power supply system 200, the power supply apparatus 1 and the power receiving apparatus 2 have the same configurations as those of the first embodiment except that they further include a fourth switch M4, an inverter device 14, and a connection detection unit 15.

Some USB connectors have a function for detecting an insertion of a USB cable plug. In the second embodiment, the USB connector including such a function is employed. As shown in FIG. 5, the USB connectors 8 in the power supply apparatus 1 and the power receiving apparatus 2 include the connection detection units 15 for detecting the insertion of the USB cable plug 11.

The connection detection unit 15 detects whether or not the USB cable plug 11 is inserted and outputs an ID signal which is a signal for detecting the insertion of the USB cable plug 11. The connection detection unit 15 outputs a high-level ID signal at the time of the insertion and removal of the connection cable 3 and outputs a low-level ID signal when the connection cable 3 is stably connected.

The fourth switch M4 is disposed between the AC coupling capacitor C1 and the first power supply line VBUS. The fourth switch M4 is comprised of an FET. An output terminal of the inverter device 14 is connected to the gate of the fourth switch M4. The ID signal is input to the input terminal of the inverter device 14. The fourth switch M4 switches a state in which the USB power delivery controller 9 is connected to the first power supply line VBUS and a state in which the USB power delivery controller 9 is disconnected from the first power supply line VBUS according to the ID signal.

In addition to the power supply control signal, the ID signal is input to the signal generation circuit 10. The signal generation circuit 10 controls the surge absorber circuit 7 based on the power supply control signal and the ID signal. Other than selecting the constant voltage diode suitable for the selected power supply voltage according to the power supply control signal, the signal generation circuit 10 can generate a signal for disconnecting all of the first to third constant voltage diodes T1 to T3 from the first power supply line VBUS.

An operation of the power supply system 200 according to the second embodiment shall be explained as follows. At the time of the insertion of the connection cable 3, the ID signal becomes a high level. The ID signal is inverted by the inverter device 14, and the fourth switch M4 is switched off. Thus, the input terminal of the USB power delivery controller 9 for the PD signal is disconnected from the first power supply line VBUS.

As described above, when the power supply apparatus 1 and the power receiving apparatus 2 are connected by the connection cable 3, the specified power supply voltage of 5 V is selected in the power supply apparatus 1 and the power receiving apparatus 2. Accordingly, the signal generation circuits 10 in the power supply apparatus 1 and the power receiving apparatus 2 firstly generate the SW control signal for turning on the third constant voltage diode T3 having the breakdown voltage characteristics that correspond to the power supply voltage of 5 V. It is thus possible to appropriately reduce the surge voltage that is generated at the time of the insertion of the connection cable 3.

When the connection cable 3 is stably connected, the ID signal becomes a low level. The ID signal is inverted by the inverter device 14, and the fourth switch M4 is switched on. Thus, the first power supply line VBUS is connected to the input terminal of the USB power delivery controller 9 for the PD signal, thereby enabling the PD signal communication. The USB power delivery controllers 9 in the power supply apparatus 1 and the power receiving apparatus 2 generate the power supply control signal according to the PD signal that has been input. At this time, the signal generation circuit 10 disconnects all of the first to third constant voltage diodes T1 to T3 from the first power supply line VBUS.

At the time of the removal of the connection cable 3, the ID signal becomes a high level. The ID signal is inverted by the inverter device 14, and the fourth switch M4 is switched off. Thus, the input terminal of the USB power delivery controller 9 for the PD signal is disconnected from the first power supply line VBUS. At this time, the signal generation circuits 10 in the power supply apparatus 1 and the power receiving apparatus 2 select one of the first constant voltage diode T1, the second constant voltage diode T2, and the third constant voltage diode T3 according to the selected power supply voltage. It is thus possible to appropriately reduce the surge voltage that is generated at the time of the removal of the connection cable 3 according to the selected power supply voltage.

As described above, in the second embodiment, it is possible to switch the state in which the USB power delivery controller 9 is connected to the first power supply line VBUS and the state in which one of the constant voltage diodes is connected to the first power supply line VBUS according to the ID signal from the connection detection unit 15. Therefore, the constant voltage diode becomes activated at the time of the insertion and removal of the connection cable 3, and the PD signal input terminal of the USB power delivery controller 9 is disconnected from the first power supply line VBUS.

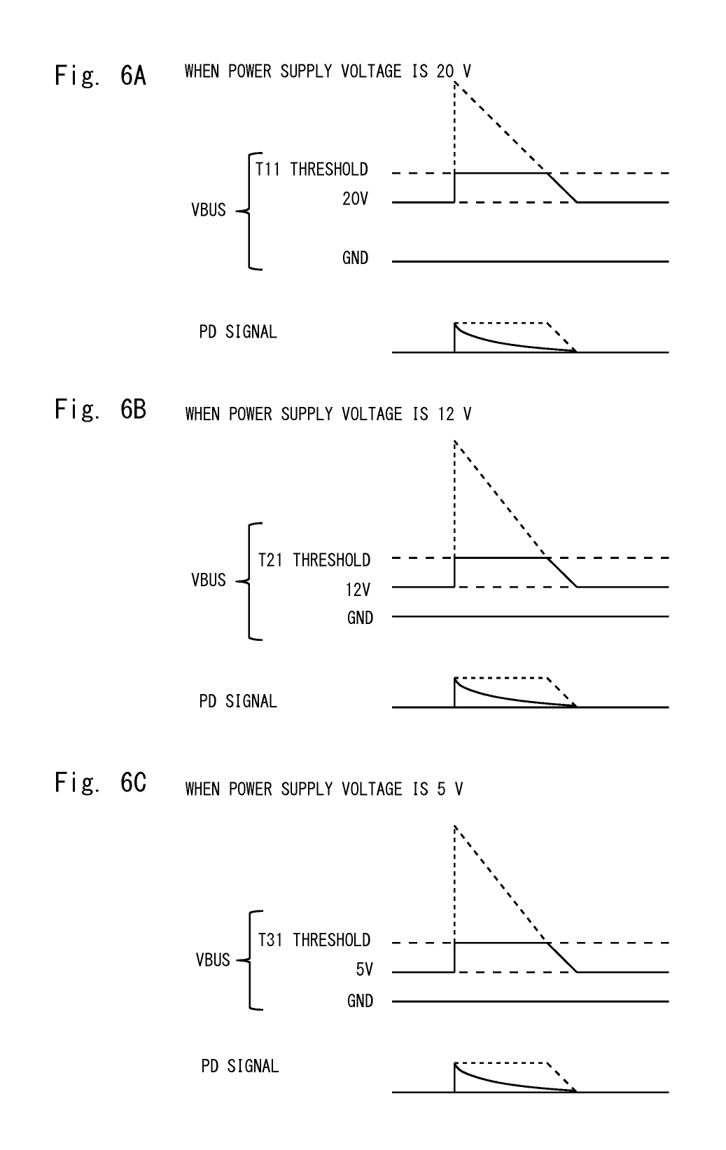

FIGS. 6A to 6C are graphs showing waveforms of the surge voltage at the time of the removal of the connection cable 3 in the power supply system according to the second embodiment. FIG. 6A shows the case when 20 V is selected as the power supply voltage, FIG. 6B shows the case when 12 V is selected as the power supply voltage, and FIG. 6C shows the case when 5 V is selected as the power supply voltage. A breakdown voltage of the first constant voltage diode T1 shall be referred to as a T11 threshold, a breakdown voltage of the second constant voltage diode T2 shall be referred to as a T21 threshold, and a breakdown voltage of the third constant voltage diode T3 shall be referred to as a T31 threshold.

In the second embodiment, as shown in FIGS. 6A to 6C, the surge voltage at the time of hot-swapping can be effectively reduced when any one of the power supply voltages is selected. Further, at the time of the insertion and removal of the connection cable 3, the USB power delivery controller 9 is disconnected from the first power supply line VBUS. Thus, the PD signal communications via the first power supply line VBUS will not be performed at the time of the insertion and removal of the connection cable 3.

Hence, the breakdown voltages of the first to third constant voltage diodes T1 to T3 can be lower than those of the first embodiment. More specifically, the T11 threshold is lower than the T1 threshold, the T21 threshold is lower than the T2 threshold, and the T31 threshold is lower than the T3 threshold. It is thus possible to reduce the surge voltage so that it is lower than that in the first embodiment.

Moreover, in the state in which the connection cable 3 is stably connected, all of the first to third constant voltage diodes T1 to T3 are disconnected from the first power supply line VBUS. This reduces an influence of the first to third constant voltage diodes T1 to T3 on the PD signal communications (FSK communications) which are performed by the USB power deliver controller 9 via the first power supply line VBUS.

### Third Embodiment

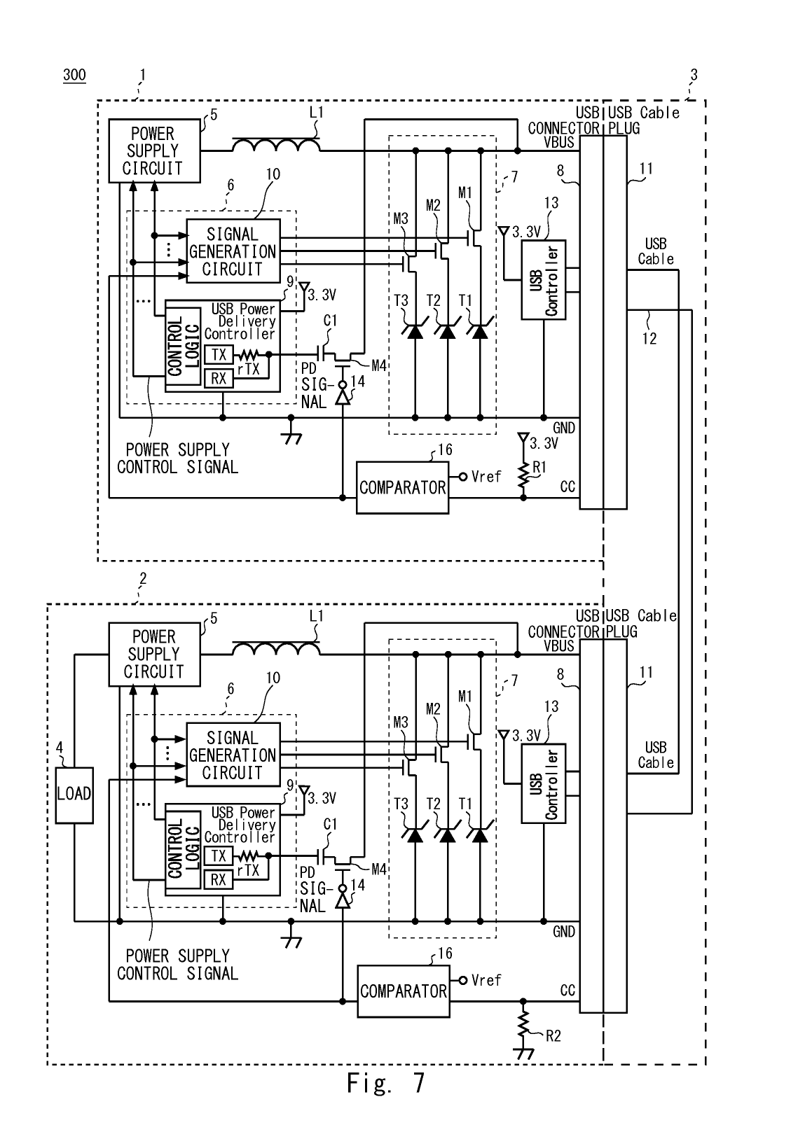

A configuration of a power supply system 300 according to a third embodiment shall be explained with reference to FIG. 7. Hereinafter, a description of contents similar to those of the first embodiment shall be omitted, and contents different from those of the first embodiment shall be described.

Some USB connectors have a function of distinguishing between the power supply apparatus 1 and the power receiving apparatus 2 in addition to the function of detecting an insertion of a USB cable plug. In the third embodiment, the USB connector having such function shall be employed.

As shown in FIG. 7, the USB connector 8 includes a CC (Control Channel) terminal. A pull-up resistor R1 is connected to the CC terminal of the USB connector 8 in the power supply apparatus 1. A pull-down resistor R2 is connected to the CC terminal in the power receiving apparatus 2. The power supply apparatus 1 and the power receiving apparatus 2 further include comparators 16.

When the power supply apparatus 1 and the power receiving apparatus 2 are not connected, the CC terminal in the power supply apparatus 1 is a high level and the CC terminal in the power receiving apparatus 2 is a low level. When the power supply apparatus 1 and the power receiving apparatus 2 are connected, the CC terminals in the power supply apparatus 1 and the power receiving apparatus 2 will become a middle level by a resistance voltage divider. The comparator 16 compares the level of the CC terminal which will be input with a reference signal Vref so as to detect a middle level signal.

The signal detected by the comparator 16 can be used as a signal that plays a role similar to that of the ID signal of the second embodiment. It is thus possible to switch the state in which the USB power delivery controller 9 is connected to the first power supply line VBUS and the state in which one of the constant voltage diodes is connected to the first power supply line VBUS. Thus, it is possible to reduce the surge voltage more than it is reduced in the first embodiment. Additionally, it is possible to reduce the influence of the first to third constant voltage diodes T1 to T3 on the PD signal communications which are performed by the USB power deliver controller 9 via the first power supply line VBUS.

### Other Embodiment

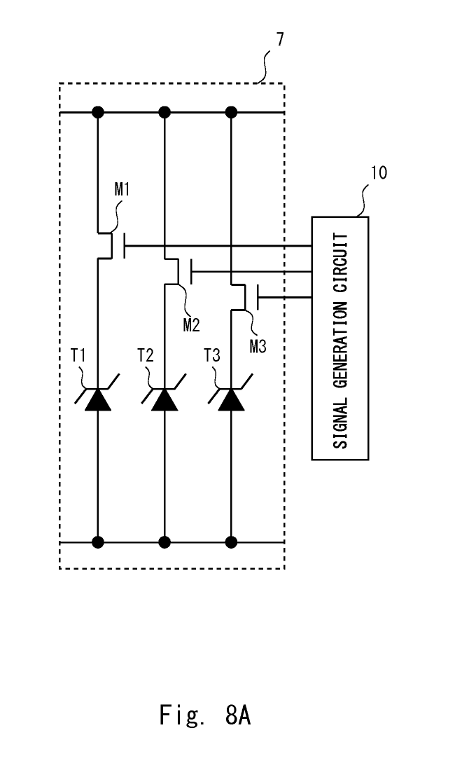

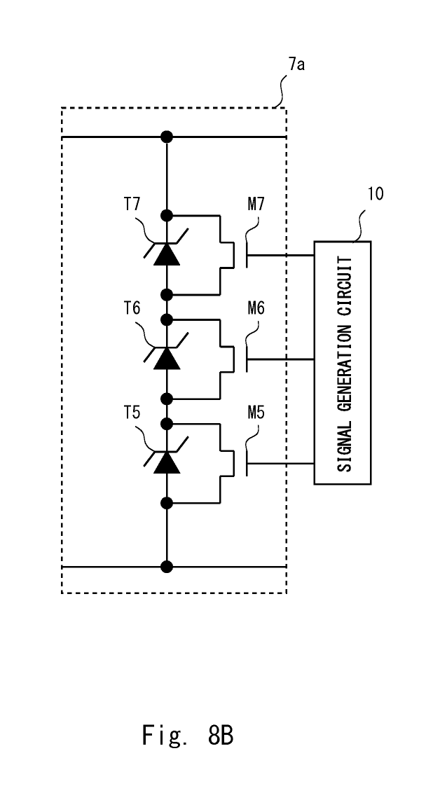

In the above embodiments, as shown in FIG. 8A, the first constant voltage diode T1, the second constant voltage diode T2, and the third constant voltage diode T3 in the surge absorber circuit 7 are connected in parallel between the first power supply line VBUS and the second power supply line GND.

In the above embodiments, a surge absorber circuit 7a shown in FIG. 8B can be used in place of the surge absorber circuit 7. As shown in FIG. 8B, the surge absorber circuit 7a includes a fifth constant voltage diode T5, a sixth constant voltage diode T6, and a seventh constant voltage diode T7 that are connected in series.

The fifth constant voltage diode T5 has breakdown voltage characteristics that are suitable for the power supply voltage of 5 V. To be specific, the fifth constant voltage diode T5 has a breakdown voltage corresponding to the sum of the power supply voltage 5 V and the allowable surge voltage. The sixth constant voltage diode T6 has breakdown voltage characteristics that are suitable for the power supply voltage of 7 V. To be specific, the sixth constant voltage diode T6 has a breakdown voltage corresponding to the sum of the power supply voltage 7 V and the allowable surge voltage.

The seventh constant voltage diode T7 has breakdown voltage characteristics that are suitable for the power supply voltage of 8 V. To be specific, the seventh constant voltage diode T7 has a breakdown voltage corresponding to the sum of the power supply voltage 8 V and the allowable surge voltage. The fifth switch M5, the sixth switch M6, and the seventh switch M7 are connected to the fifth constant voltage diode T5, the sixth constant voltage diode T6, and the seventh constant voltage diode T7, respectively.

The fifth switch M5, the sixth switch M6, and the seventh switch M7 are controlled according to the SW control signal input from the signal generation circuit 10, and the fifth constant voltage diode T5, the sixth constant voltage diode T6, or the seventh constant voltage diode T7 that is suitable for the selected power supply voltage is selected.

When the power supply voltage of 20 V is selected, the fifth switch M5 is switched off, the sixth switch M6 is switched off, and the seventh switch M7 is switched off. This creates a constant voltage diode connection having breakdown voltage characteristics that are suitable for the power supply voltage of 20 V.

Alternatively, when the power supply voltage of 12 V is selected, the fifth switch M5 is switched off, the sixth switch M6 is switched off, and the seventh switch M7 is switched on. This creates a constant voltage diode connection having breakdown voltage characteristics that are suitable for the power supply voltage of 12 V.

In a further alternative, when the power supply voltage of 5 V is selected, the fifth switch M5 is switched off, the sixth switch M6 is switched on, and the seventh switch M7 is switched on. This creates a constant voltage diode connection having breakdown voltage characteristics that are suitable for the power supply voltage of 5 V.

In summary, when the surge absorber circuit 7a is used, the constant voltage diode having appropriate breakdown voltage characteristic can be selected according to the selection from among the power supply voltages of 20 V, 12 V, and 5 V. Therefore, an operation of unnecessarily drawing a current from the first power supply line VBUS will not be caused to occur during a normal operation. In addition, when any one of the power supply voltages is selected, it is possible to effectively reduce the surge voltage at the time of hot-swapping, thereby it is possible to avoid breaking of the input terminal of the USB power delivery controller 9 for the PD signal.

Although the invention made by the present inventor has been explained in detail based on the embodiments, it is obvious that the invention is not limited to the above embodiments that have been already explained, and various modifications can be made without departing from the scope of the invention.

The above embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

The first to third embodiments can be combined as desirable by one of ordinary skill in the art.

What is claimed is:

1. A power supply system including a USB interface for performing a power supply operation from a power supply circuit via the USB interface, the power supply system comprising:
a first power supply line of the power supply circuit that outputs a plurality of power supply voltages;
a plurality of constant voltage diodes that each have breakdown voltages corresponding to the plurality of power supply voltages; and
a control circuit that selects one of the plurality of power supply voltages as a power supply voltage which will be output from the power supply circuit and selects one of the plurality of constant voltage diodes which will be connected to the first power supply line according to the selected power supply voltage.

2. The power supply system according to claim 1, wherein the control circuit performs a power delivery signal communication for selecting one of the plurality of power supply voltages according to a USB device that is connected to the USB interface using the first power supply line.

3. The power supply system according to claim 1, further comprising a connection detection unit that detects whether or not the USB device is connected to the USB interface, wherein
a state in which the control circuit is connected to the first power supply line and a state in which the constant voltage diode is connected to the first power supply line is switched based on a detection signal from the connection detection unit.

4. The power supply system according to claim 3, wherein
the constant voltage diode is connected to the first power supply line at the time of an insertion of the USB device into the USB interface and a removal of the USB device from the USB interface, and
the control circuit is connected to the first power supply line when the USB interface is connected to the USB device.

5. The power supply system according to claim 3, wherein
when the USB device is inserted into the USB interface, the constant voltage diode having the breakdown voltage corresponding to a power supply voltage that is the smallest among the plurality of power supply voltages is connected to the first power supply line, and
when the USB device is removed from the USB interface, the constant voltage diode having the breakdown voltage corresponding to the power supply voltage that has been selected according to the USB device is connected to the first power supply line.

6. The power supply system according to claim 1, wherein
the plurality of constant voltage diodes are connected in parallel via switches, respectively, between the first power supply line and a second power supply line, and
the control circuit controls the switches so as to select the constant voltage diode which will be connected to the first power supply line.

7. The power supply system according to claim 1, wherein
the plurality of constant voltage diodes are connected in series between the first power supply line and the second power supply line,
the power supply system includes a plurality of switches that are connected to the plurality of constant voltage diodes, respectively, and
the control circuit controls the switches so as to select the constant voltage diode which will be connected to the first power supply line.
